(19) United States
(12) Patent Application Publication
(10) Pub. No.: US 2026/0147319 A1
(43) Pub. Date: May 28, 2026

(54) LOW AREA WIDE RANGE TIME TO DIGITAL CONVERTER

(71) Applicant: NXP USA, Inc., Austin, TX (US)

(72) Inventors: Devesh Pratap Singh, Bijnor (IN); Soumyashib Das, Burdwan (IN); Manish Kumar Upadhyay, New Delhi (IN)

(21) Appl. No.: 19/379,093

(22) Filed: Nov. 4, 2025

(30) Foreign Application Priority Data
Nov. 12, 2024 (IN) 202441087227

(51) Int. Cl. G04F 10/00

(52) U.S. Cl. CPC G04F 10/005

(57) ABSTRACT

A time to digital converter including multiple programmable buffers coupled in series for receiving a pulse signal, latches configured to provide binary values indicative of the state of the buffers at the end of a timing pulse asserted on the pulse signal, and a phase converter configured to convert the binary values into a digital output value indicative of a measured delay of the timing pulse. Each of the buffers is configured with an adjustable delay based on a delay select input. The adjustable delay is used to select from among multiple different transition delays of each buffer. The buffers may be configured to be compatible with a standard cell layout. The buffers may be configured as standard cell logic gate with modified connections. The buffers may be calibrated by selecting a fastest delay value that does not cause overflow in response to a calibration pulse.

### BACKGROUND

### Field

The present disclosure relates in general to time to digital conversion, and more particularly to a low area, wide range time to digital converter.

### Description of the Related Art

A time to digital converter (TDC) has versatile use in clock and voltage measurement circuits. For measuring clock signals on a system-on-chip (SoC), a TDC might require a wide input clock frequency range to handle a wide range of frequencies present on SoC, such as from the megahertz (MHz) frequency range to the gigahertz (GHz) frequency range. Delay line based TDCs are frequently used in clock bult-in, self-test (BIST) and other time measurement circuits which require relatively good resolution. The delay line may be formed by a series of substantially identical unit delays, in which the unit delay should be as small as reasonably available. The delay line may be implemented using digital standard cells, which reduces overall area as compared to using analog delay cells. Analog type or differential delay elements require larger power and area.

The advent of the fin field-effect transistor (finFET) process have benefitted digital delay units with lower delays. Standard cell-based unit delay cells can achieve reasonable delays within a very compact area but have a lower limit especially at slow process-voltage-temperature (PVT) corners. The variation across PVT corners, however, requires a relatively long delay line in order to cater to wide types of inputs (e.g., various clocks provided on typical SoC configurations). The base unit delay using a standard cell inverter between the fast corner and the slow corner varies by as much as a factor of two. Having a larger unit delay would degrade the resolution further on the slow corner. In order to increase measured input time range by two while maintaining resolution for a conventional configuration, the delay line length would need to be doubled consuming valuable space and reducing efficiency.

### BRIEF DESCRIPTION OF THE DRAWINGS

Embodiments of the present invention are illustrated by way of example and are not limited by the accompanying figures. Similar references in the figures may indicate similar elements. Elements in the figures are illustrated for simplicity and clarity and have not necessarily been drawn to scale.

FIG. 1 is a simplified schematic and block diagram of a time to digital converter (TDC) implemented according to one embodiment.

FIG. 2 is a timing diagram illustrating operation of the TDC of FIG. 1 according to one embodiment for measuring a period of a clock signal under test.

FIG. 3 is a detailed schematic diagram of a delay line of FIG. 2 implemented according to one embodiment which may be used as the delay line of FIG. 1.

FIG. 4 is a schematic diagram of a portion of a delay line implemented according to an alternative embodiment which may be used as the delay line of FIG. 1.

FIG. 5 is a schematic diagram of a programmable buffer implemented according to one embodiment that may be used as any one up to all of the buffers B1-BN of the delay line of FIG. 1.

FIG. 6 is a tabular diagram illustrating exemplary delay times of a specific implementation of the buffer of FIG. 5 based on settings of the enable signals of DSEL for the fastest and slowest corners of process-voltage-temperature (PVT) according to one embodiment.

FIG. 7 is a plot of delay times of the buffer of FIG. 5 (having a specific implementation as that for FIG. 6) for each of the four settings of the enable signals of DSEL (00b, 01b, 10b, 11b) for various PVT conditions according to one embodiment.

FIG. 8 is a schematic diagram of a programmable buffer implemented according to another embodiment that may be used as any one up to all of the buffers B1-BN of the delay line of FIG. 1.

FIG. 9 is a flowchart diagram illustrating a delay line measurement test procedure according to one embodiment that may be used to determine the total timing of the delay line of FIG. 1 for a given implementation.

FIG. 10 is a flowchart diagram illustrating a first calibration procedure for calibrating the delay line of FIG. 1 according to one embodiment.

FIG. 11 is a flowchart diagram illustrating a second calibration procedure for calibrating the delay line of FIG. 1 according to another embodiment.

FIG. 12 is a diagram of a standard cell structure configured to implement the buffer of FIG. 5 according to one embodiment.

### DETAILED DESCRIPTION

A time to digital converter as described herein includes multiple programmable buffers coupled in series for receiving a pulse signal, latches configured to provide binary values indicative of the state of the buffers at the end of a timing pulse asserted on the pulse signal, and a phase converter configured to convert the binary values into a digital output value indicative of a measured delay of the timing pulse. Each of the buffers is configured with an adjustable delay based on a delay select input. The adjustable delay is used to select from among multiple different transition delays of each buffer. The buffers may be configured to be compatible with a standard cell layout. The buffers may be configured as standard cell logic gate with modified connections.

Each buffer may include an input inverting stage coupled between an input node and a middle node and an output inverting stage between the middle node and an output node. The adjustable delay is configured to select, based on the delay select input, a rising edge delay of the middle node in response to a falling edge of the input node, and to select a falling edge delay of the output node in response to the rising edge delay of the middle node.

The delay select input may include a first enable signal and a second enable signal, in which each buffer includes a first programmable branch coupled to the middle node configured to adjust the rising edge delay of the middle node based on the first enable signal, and a second programmable branch coupled to the output node configured to adjust the falling edge delay of the output node based on a second enable signal. In one embodiment, each buffer may be configured in complementary MOS (CMOS), in which the first programmable branch includes a P-type MOS (PMOS) transistor and an N-type MOS (NMOS) transistor each having a gate terminal receiving the first enable signal, and in which the second programmable branch comprises a PMOS transistor and an NMOS transistor each having a gate terminal receiving the second enable signal.

In another embodiment, each buffer may include an additional programmable branch coupled to the middle node and configured to adjust the rising edge delay of the middle node based on the second enable signal. The additional branch may be beneficial for achieving desired delay values depending upon the particular semiconductor process or technology.

A controller may be provided which is configured to calibrate the buffers by applying a calibration pulse on the pulse signal, adjusting a delay select signal provided to the delay select inputs of the buffers, and selecting a fastest value of the delay select signal that does not cause overflow of the series of buffers in response to the calibration pulse.

A method of converting time to a digital value as described herein includes providing multiple programmable buffers coupled in series receiving a pulse signal, in which each buffer is configured with an adjustable delay based on a delay select input, asserting a timing pulse having a leading edge and a trailing edge on the pulse signal, latching outputs of the buffers in response to the trailing edge of the timing pulse and providing a corresponding set of binary values, and converting the binary values into a digital output value indicative of a duration of the timing pulse.

The method may include providing a delay select signal to the delay select input of each of the buffers to select from among multiple different transition delays from an input node to an output node of each of the buffers. The method may include providing an input inverting stage coupled between an input node and a middle node and an output inverting stage between the middle node and an output node for each buffer, and providing a delay select signal to the delay select input of each buffer to select a rising edge delay of the middle node in response to a falling edge of the input node and to select a falling edge delay of the output node in response to the rising edge delay of the middle node for each buffer.

The method may include providing a first programmable branch coupled to the middle node configured to adjust the rising edge delay of the middle node based on a first enable signal, providing a second programmable branch coupled to the output node configured to adjust the falling edge delay of the output node based on a second enable signal, and providing the first and second enable signals to the delay select input of each buffer to select from among multiple different transition delays from an input node to an output node of each buffer. The method may include providing a third programmable branch coupled to the middle node configured to further adjust the rising edge delay of the middle node based on the second enable signal.

The method may include providing each of the buffers to be compatible with a standard cell layout. The method may include providing each of the buffers as a standard cell logic gate with modified connections.

The method may include providing a fastest delay select value of multiple different delay select values to the delay select input of each of the buffers, asserting a calibration pulse on the pulse signal, determining whether an overflow condition occurs, and if the overflow condition occurs, incrementing the delay select value to a next slowest delay select value and repeating the asserting a calibration pulse and determining whether an overflow condition occurs until the overflow condition does not occur.

The method may include providing a fastest delay select value of multiple different delay select values to the delay select input of each of the buffers and performing calibration, which includes asserting a calibration pulse on the pulse signal, determining whether an overflow condition of the buffers occurs, if the overflow condition does not occur, repeating the performing calibration for up to a maximum count while the overflow condition does not occur, and if the overflow condition occurs, incrementing the delay select value to a next slowest delay select value and repeating the performing calibration.

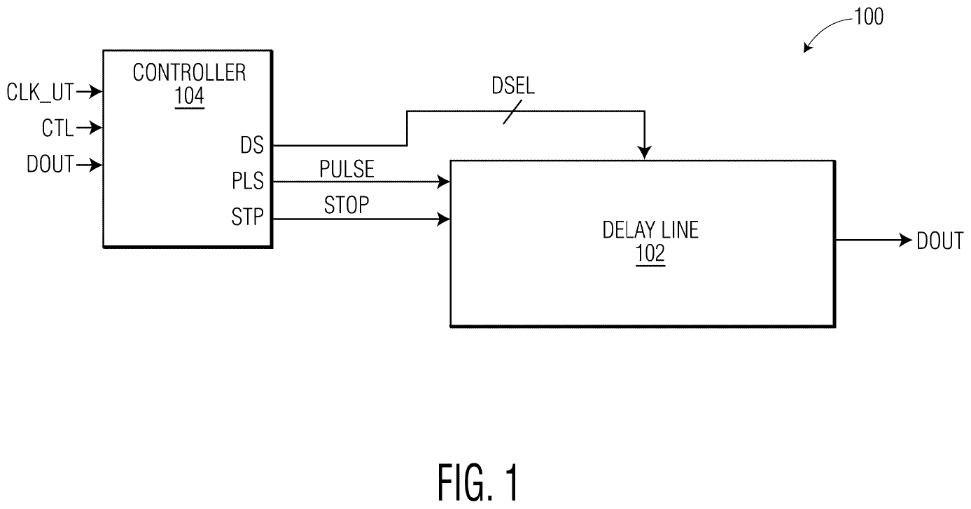

FIG. 1 is a simplified schematic and block diagram of a time to digital converter (TDC) 100 implemented according to one embodiment. The TDC 100 includes a delay line 102 and a controller 104 configured to control operation of the delay line 102. The controller 104 has a clock input receiving a clock under test CLK_UT, a control input receiving one or more control signals CTL, a sample input receiving DOUT from the output of the delay line 102, a pulse output PLS providing a pulse signal PULSE to an input of the delay line 102, a stop output STP providing a signal STOP to another input of the delay line 102, and a delay select output DS providing a delay select signal DSEL to a control input of the delay line 102. The DSEL signal is used to adjust the delay of each delay unit of the delay line 102 as further described herein. A timing pulse asserted on the PULSE signal has a duration or width that represents a timing delay to be measured. DOUT is a digital output value that is proportional to the duration or width of the timing pulse and thus provides a measured value of the delay of the timing pulse. DOUT is provided back to be sampled by the controller 104.

In operation, a selected clock signal or other timing signal to be tested is provided as CLK_UT to the controller 104. Although CLK_UT may be a clock signal in which it is desired to measure its period or duty cycle, it may also be a pulse signal or the like in which it is desired to measure the pulse duration. The CTL signals are used to control operation of the controller 104 for controlling the TDC 100 to measure one or more timing parameters of CLK_UT. For example, the TDC 100 may be used to measure the period or duty cycle or pulse duration of CLK_UT, and multiple measurements of any given parameter may be made over time. The controller 104 may perform an initialization or reset phase between measurement cycles by keeping PULSE high for as long as necessary so that a logic one propagates through the delay line 102. The STOP signal may then be pulsed high then low to effectively clear the delay line 102 for a new measurement. During each measurement cycle, PULSE is pulled low to begin a timing pulse and STOP is asserted high at the end of the timing pulse. When STOP is asserted, the delay line 102 develops and outputs DOUT as a digital value provided back to the controller 104. In addition, the controller 104 may perform calibration of the delay line 102 for determining an optimal value of DSEL as further described herein.

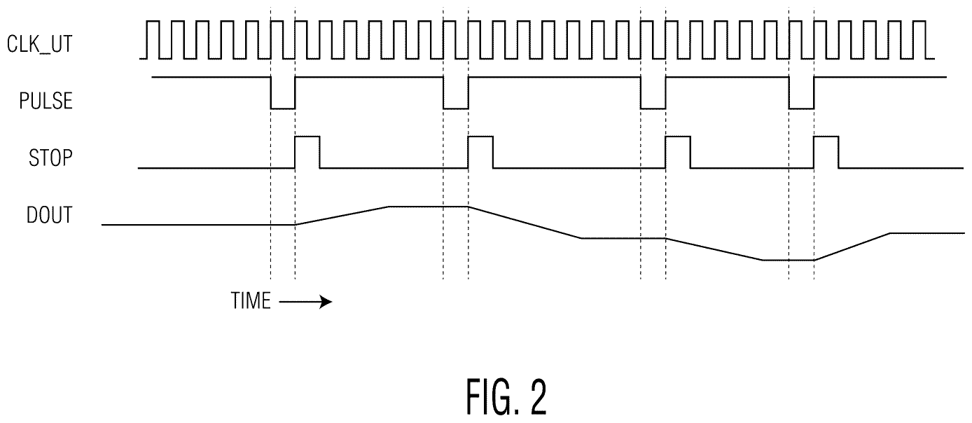

FIG. 2 is a timing diagram illustrating operation of the TDC 100 according to one embodiment for measuring a period of CLK_UT. The signals CLK_UT, PULSE, STOP and DOUT are plotted versus time. CLK_UT is shown as a typical clock signal with a selected frequency and 50% duty cycle. Although not plotted, the CTL signals are used to instruct the controller 104 to periodically measure the period of CLK_UT. In the illustrated case, the CTL signals instruct the controller 104 to make periodic measurements of the period of CLK_UT. In response to CTL, the controller 104 develops periodic timing pulses on PULSE, in which PULSE remains high between the periodic measurements, goes low coincident with a rising edge of CLK_UT and then goes back high coincident with the next rising edge of CLK_UT for each timing pulse for measurement. The controller 104 normally keeps STOP low between measurements, then pulses STOP high coincident with PULSE going back high, and then pulls STOP back low before the next measurement. Each pulse on STOP triggers the delay line 102 to develop a new value of DOUT, which changes with each new measurement. Once DOUT settles to its new value, it is sampled by the controller 104 in which the sampled value is indicative of a measured delay of a corresponding timing pulse.

The TDC 100 may be used as a clock built-in, self-test (BIST) application for a corresponding SoC (not shown). The clock BIST application does not require contiguous measurement of clock periods, in which periods can be measured intermittently. This does not impact the final peak-to-peak jitter measurements or duty cycle measurements as a large number of samples may be made to ensure worst-case periods are measured. At the end of each timing pulse on the PULSE signal as triggered by the STOP signal, the delay line 102 starts calculating DOUT. Separating the timing pulses on the PULSE signal provides more time to perform computations for measurement, which provides a low area and low power implementation. The delay between each pair of timing pulses is often available for other time measurement applications such as, for example, those used in automotive applications, such as range finder, speed detection, etc.

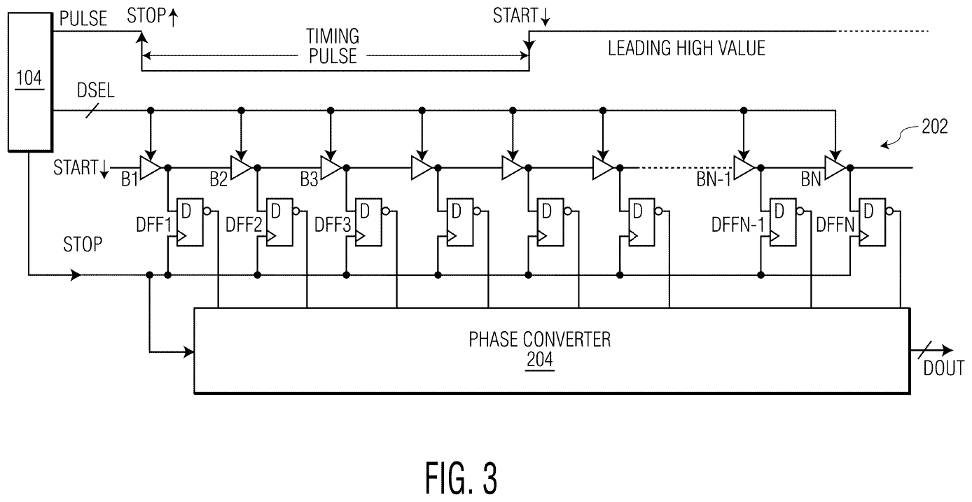

FIG. 3 is a detailed schematic diagram of a delay line 202 implemented according to one embodiment which may be used as the delay line 102 of FIG. 1. The delay line 202 includes a set of N series-coupled buffers B1, B2, B3, . . . , BN (B1-BN), a corresponding set of N D-type latches or flip-flops (DFFs) DFF1, DFF2, DFF3, . . . , DFFN (DFF1-DFFN), and a phase converter 204. Within the delay line 202, the output of B1 is coupled to the input of B2 at a first intermediate node, the output of B2 is coupled to the input of B3 at a second intermediate node, and so on up to the last buffer BN having its input coupled to the output of the second to last buffer BN-1. Each of the DFFs DFF1-DFFN has a D input coupled to a corresponding one of the series of intermediate nodes formed by the set of buffers B1-BN, and each has an inverted Q output (shown as an output with an inverting bubble) providing a binary value to a corresponding input of the phase converter 204. DSEL is shown provided to an input of each of the buffers B1-BN for adjusting buffer delay as further described herein. The STOP signal is provided to a clock input of each of the DFFs DFF1-DFFN, and also to an input of the phase converter 204.

The controller 104 is shown generating an exemplary timing pulse on the PULSE signal having a leading falling edge shown as a signal START and a trailing rising edge shown as a signal STOP. The timing delay to be measured starts with START and ends with STOP. Although not shown, the controller 104 may temporarily pulse the STOP signal high to initially clock each of the DFFs DFF1-DFFN so that each of the inverted outputs provided to the phase converter 204 are initially pulled low. The PULSE signal is provided to the input of the first buffer B1, which begins with a leading high value that propagates through each buffer of the series of buffers B1-BN so that each of the intermediate nodes are initially pulled high. The timing pulse propagates through the series of buffers B1-BN, in which the leading high value of PULSE is followed by START at the leading edge of the timing pulse, which is then followed by STOP at the trailing edge of the timing pulse pulling PULSE back high. The controller 104 asserts the STOP signal coincident with STOP so that the phase converter 204 is triggered to convert the outputs of the DFFs DFF1-DFFN into a value provided as DOUT. In this manner, the leading intermediate nodes are pulled low as START propagates through the buffers B1-BN, which are clocked as high values provided to the corresponding inputs of the phase converter 204 upon assertion of STOP. The phase converter 204 operates as a thermometric to binary converter, so that the number of leading logic “1s” output by the DFFs are converted by the phase converter 204 to a corresponding digital value DOUT that is proportional to the measured delay of the timing pulse asserted on PULSE.

In particular, when PULSE is initially asserted low at the beginning of the timing pulse, the falling edge shown as START propagates through the buffers B1-BN in which the intermediate nodes between the buffers are sequentially driven low. When PULSE is asserted high triggering STOP at the end of the timing pulse, each of the DFFs DFF1-DFFN are clocked so that the collective state of the intermediate nodes between the buffers B1-BN are sampled by the DFFs and provided as corresponding binary signals to the phase converter 204. Since, in this case, the intermediate nodes from the first left-most buffer B1 towards the last right-most buffer BN are pulled low so that the total number of nodes pulled low represents the time duration of the timing pulse between START and STOP (or between the falling edge of PULSE to the next rising edge of PULSE). When clocked, the inverted outputs of the DFFs DFF1-DFFN are provided to the phase converter 204. For example, if START propagates only through the first 10 buffers, then the binary output of the DFFs is 111111111100000 . . . 000b (in which an appended ‘b’ denotes a binary value). The phase converter 204 adds the total number of 1's output by the DFFs (thermometer value) and outputs DOUT as a digital value indicative of the measured delay of the timing pulse. Assuming M=127 for a total of 127 buffers B1-B127, then DOUT may be represented as a 7-bit digital value. For the above example of 111111111100000 . . . 000b, then DOUT=0001010b, which is the equivalent of the decimal number 10. The decimal number 10 is proportional to the measured delay of the timing pulse between START and STOP.

It is noted that each DFF may generally be configured as any type of bistable multivibrator or “latch” having at least two stable digital states that can store information. Each DFF or latch is configured to change state by adjusting an input and applying one or more control inputs (e.g., set, reset, clear, clock, etc.). In the illustrated embodiments, each DFF latches its input to its output in response to a clock signal transition generated by STOP, although alternative configurations are possible and contemplated. It is appreciated that many possible variations are contemplated for using or otherwise implementing the delay line 102. For example, although PULSE is described as having a normal high state which transitions low to initiate a timing pulses for measurement, PULSE may instead have a normal low state which transitions high to initiate the timing pulses for measurement. Also, although the inverting outputs of the DFFs DFF1-DFFM are shown provided to the phase converter 204, the non-inverting output of the DFFs may instead be used. The phase converter 204 is configured accordingly. In addition, the buffers B1-BN are shown as non-inverting buffers but may instead be implemented as inverting buffers (e.g., inverters) when combined with using corresponding alternating inverting and non-inverting outputs of the DFFs.

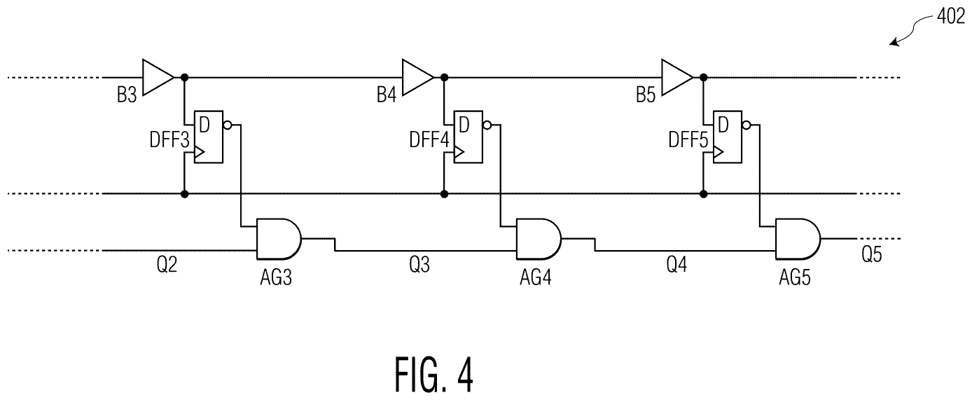

FIG. 4 is a schematic diagram of a portion of a delay line 402 implemented according to an alternative embodiment which may be used as the delay line 102 of FIG. 1. The delay line 402 is substantially similar to the delay line 202, in which only a portion is shown including the buffers B3, B4, and B5 and the DFFs DFF3, DFF4, and DFF5. The delay line 402 further includes a series of N 2-input Boolean AND gates AG1-AGN, which includes an AND gate for each of the N buffers and N DFFs. Thus, each unit cell has a buffer, a capture DFF, and an AND gate for bubble correction. Bubble correction is provided to correct for bubble errors in the delay line when one or more of the unit cells are incorrectly flipped in a prior measurement potentially interfering with the current measurement.

Only the AND gates AG3, AG4, and AG5 are shown corresponding with the buffers B3-B5 and the corresponding DFFs DFF3-DFF5. The AND gate AG3 has a first input receiving the inverted Q output of DFF3, a second input receiving Q2, which is the output of the AND gate AG2 (not shown) from the prior unit stage, and an output providing Q3. The AND gate AG4 has a first input receiving the inverted Q output of DFF4, a second input receiving Q3, and an output providing Q4. The AND gate AG5 has a first input receiving the inverted Q output of DFF5, a second input receiving Q4, and an output providing Q5. The pattern repeats for the entire delay line 402. Although not shown in FIG. 4, the phase converter 204 is provided but receives the Q1-QN values rather than the outputs of the DFFs.

The addition of the AND gates AG1-AGN provides bubble correction to correct for bubble errors in the delay line. With bubble correction and intermittent sampling, the output of delay line 402 is ensured to be a thermosteric code. The width of cell is governed by the corresponding capture DFF, so that the addition of the AND gates AG1-AGN do not significantly increase the overall area of the delay line 402 as compared to the delay line 103. Thus phase computation is performed using a compact area thermometric to binary converter.

In most technologies used for implementing the delay line 102 (e.g., implemented according to delay line 202 or 402 or the like), the unit delay, meaning the delay through each of the buffers B1-BN, exhibits mismatch in the rise and fall times across process-voltage-temperature (PVT) variations, which causes duty cycle degradation. If timing pulses indicative of clock periods (of CLK_UT) were fed contiguously in the delay line with little delay between, duty cycle degradation might make the timing pulses die before reaching the end of delay line. This is a frequent problem with delay lines. Using intermittent timing pulses relaxes the duty cycle degradation requirement for the unit delay. As described herein, only a falling edge (e.g., START) traverses through the delay line after a long steady high value as shown in FIG. 3. As the rising edge of PULSE (e.g., STOP) enters delay line, the states of the intermediate nodes are captured by the DFFs in response to the STOP signal coincidentally being asserted high. In this manner, only the falling edge delay of each timing pulse, meaning the propagation of START through the delay line, is used in each conversion. The corresponding rising edge propagation delay is not used in the measurements (other than triggering the end of each timing pulse).

As described herein, the rise and fall mismatch insensitivity to add programmability in the delay value is exploited while maintaining the standard cell layout structure for each unit delay which achieves minimal area and resolution degradation. Since only the falling edge delay is considered, the duty cycle of delay unit may be adjusted to alter the falling edge delay. This allows easy implementation without significantly increasing the delay of inverter. As described herein, the unit delay may be implemented as two-stage buffer, so that each of the capture DFFs use the intermediate nodes transitioned by the falling edge for capture. It is noted that standard cell flip-flops have different setup and hold time for rising edge capture versus falling edge capture.

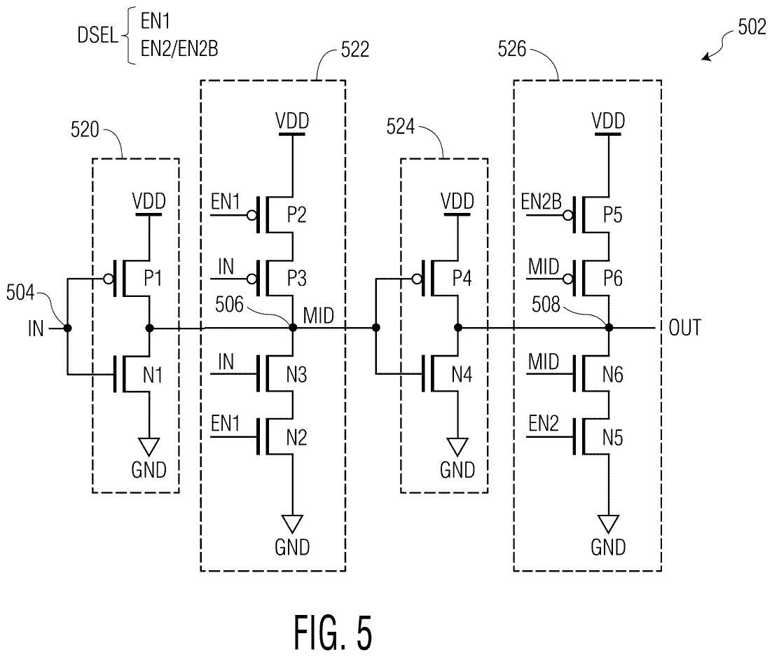

FIG. 5 is a schematic diagram of a programmable buffer 502 implemented according to one embodiment that may be used as any one up to all of the buffers B1-BN of the delay line 102 (e.g., 202 or 402 or the like). The buffer 502 is implemented as a two-stage buffer (2 inverting stages) in complementary MOS (CMOS) using P-type (or P-channel) MOS (PMOS) transistors and N-type MOS (NMOS) transistors coupled between a supply voltages VDD and a reference supply voltage shown as ground (GND) in which each transistor is numbered according to polarity type (e.g., P or N). The transistors may be implemented according to any suitable type of technology, such as, for example, the 16 nanometer (nm) FinFET compact technology (16FFC). FinFET transistors may be configured with selected parameters such as a selected number of fins, a selected number of fingers, and a selected CMOS multiplier, in which such parameters are selected for obtaining suitable delay values. Alternative technologies or transistor types are contemplated, in which each transistor has a control terminal (e.g., gate or base) and two current terminals (e.g., drain and source or collector and emitter or the like).

The buffer 502 has four stages, including an input inverter stage 520 formed by P1 and N1, a first programmable stage 522 formed by PMOS transistors P2 and P3 and NMOS transistors N2 and N3, a second inverter stage 524 formed by a PMOS transistor P4 and an NMOS transistor N4, and a second programmable stage 526 formed by PMOS transistors P5 and P6 and NMOS transistors N5 and N6. The buffer 502 has an input node 504 receiving an input signal IN, which is coupled to the gate terminals of P1, N1, P3 and N3. The drain terminals of P1 and N1 are coupled together at a middle node (MID) 506, which is further coupled to the gate terminals of P4, N4, P6, and N6. The drain terminals of P4 and N4 are coupled together at an output node 508 developing an output signal OUT, which is further coupled to the drain terminals of P6 and N6. The source terminals of P1, P2, P4, and P5 are coupled to VDD, and the source terminals of N1, N2, N4, and N5 are coupled to GND. The drain terminal of P2 is coupled to the source terminal of P3, the drain terminal of P5 is coupled to the source terminal of P6, the drain terminal of N2 is coupled to the source terminal of N3, and the drain terminal of N5 is coupled to the source terminal of N6.

DSEL includes at least two of multiple enable signals EN1, EN2, and EN2B, in which EN2B is an inverted version of EN2. In general, two enable signals may be used for four different delay values, three enable signals for up to eight different delay values, and so on. It is noted that DSEL need only include EN1 and EN2B in the illustrated embodiment of the buffer 502. EN1 is provided to the gate terminals of N2 and P2, and EN2B is coupled to the gate terminals of N5 and P5. The signals of DSEL (i.e., EN1 and EN2B) are set before each timing pulse measurement to program the delay of the buffer 502 (and thus the delay of each of the buffers B1-BN in the delay line 202 or 402) and remain static during the measurement. The state of EN1 determines whether MID rises (from low to high) fast or slow, and the state of EN2B determines whether OUT falls (from high to low) fast or slow.

When IN is initially high (logic “1”), N1 is turned on and P1 is turned off so that MID is low (logic “0”), and P4 is turned on while N4 is turned off so that OUT is initially high. If EN1 is programmed low (while IN is high), then P2 is precharged towards being turned on while N2 is turned off, whereas P3 is off and N3 is preset to being turned on (with little current flow since N2 is off). When IN falls in response to a falling edge of PULSE (e.g., START), P1 is turned on while N1 is turned off to pull MID high. In this case, P2 and P3 are turned on more quickly while N3 is turned off (with N2 also off) so that MID rises relatively fast. If, on the other hand, EN1 is programmed high (while IN is high), P2 and P3 are turned off while N3 and N2 are both turned on. When IN falls in response to a falling edge of PULSE (e.g., START), P1 is turned on while N1 is turned off to pull MID high. In this case, however, P2 remains turned off preventing P3 from turning fully on, whereas N3 turns off more slowly since N2 may remain at least partially on so that MID rises relatively slowly.

When IN is initially high, MID is low and OUT is initially high. If EN2B is programmed high (while MID is low), then N5 is precharged towards being turned on while P5 is turned off, whereas N6 is off and P6 is preset to being turned on (with little current flow since P5 is off). When IN falls in response to a falling edge of PULSE (e.g., START), MID is pulled high turning N4 on and P4 off so that OUT is pulled low. In this case, N5 and N6 are turned on more quickly while P6 is turned off (with P5 also off) so that OUT falls relatively fast. If, on the other hand, EN2B is programmed low (while MID is low), N5 and N6 are turned off while P5 and P6 are both turned on. When IN falls in response to a falling edge of PULSE (e.g., START) pulling MID high, N4 is turned on while P4 is turned off to pull OUT low. In this case, however, N5 remains turned off preventing N6 from turning fully on, whereas P6 turns off more slowly since P5 may remain at least partially on so that OUT falls relatively slowly.

In summary, the buffer 502 includes 2 stages, each stage including a fixed inverter and a programmable branch in which each stage may include a similar structure on both the PMOS side and the NMOS side. In one embodiment, the PMOS and NMOS structures on both sides may be configured in a symmetrical manner. The programmable portion alters the strength on either the PMOS side or the NMOS side depending upon the value of the enable signals of DSEL. Thus, for each stage, programmability makes the node (MID or OUT) rise faster or fall slower or vice-versa. In addition, the gate terminals of corresponding PMOS and NMOS devices are connected to same net, allowing continuous gate poly that may be required for a standard cell layout. As shown, the gate terminals of corresponding PMOS and NMOS devices are coupled to the same node. Thus, the gate terminals of P1 and N1 are both coupled to IN, the gate terminals of P2 and N2 are both coupled to EN1, the gate terminals of P3 and N3 are both coupled to IN, the gate terminals of P4 and N4 are both coupled to MID, the gate terminals of P5 and N5 are both coupled to EN2B, and the gate terminals of P6 and N6 are both coupled to MID.

In addition, the illustrated programmability implementation may be done to ensure that the layout can be easily implemented using standard cells retrieved from a standard cell library. A standard cell may be used to implement each of the inverters formed by P1 & N1 or P4 & N4. In addition, a selected standard cell may be used to implement each of the programmable branches. The programmable branch formed by P2, P3, N3, and N2 may be implemented by a standard cell NOR gate (modified accordingly), and the programmable branch formed by P5, P6, N5, and N6 may be implemented by a standard cell NAND gate (again, modified accordingly).

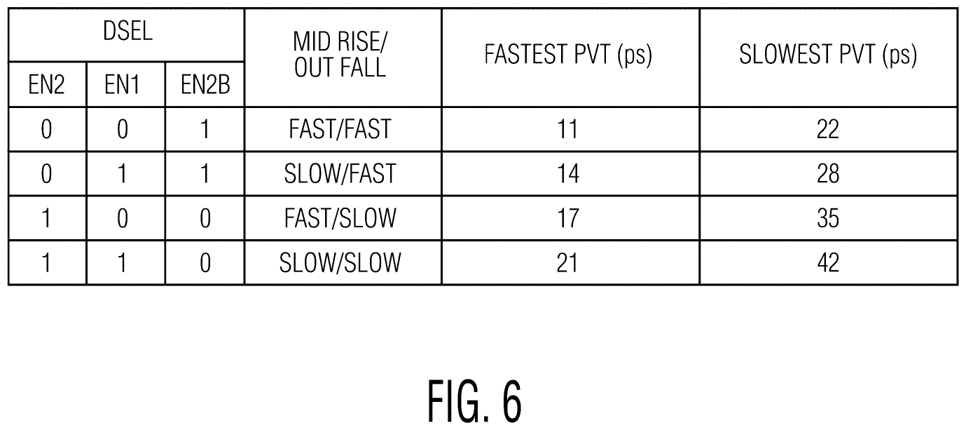

FIG. 6 is a tabular diagram illustrating exemplary delay times of a specific implementation the buffer 502 based on settings of the enable signals of DSEL for the fastest and slowest corners of PVT according to one embodiment. For purposes of simplicity of illustration, DSEL is expressed in terms of the combined enable signals EN2/EN1 as 00b, 01b, 10b, 11b from fastest delay (00b) to slowest delay (11b). It is noted that EN2 may either not be used or may be an internal signal of the controller 104 in which its inverted version EN2B may be used instead for actual programming of the buffers. The delay times for the fastest PVT corner are first considered. For the fastest delay setting 00b, the rise of MID (MID RISE) is fast and the fall of OUT (OUT FALL) is also fast providing a fastest delay time of 11 picoseconds (ps) for the fastest PVT corner. It is noted that the particular times illustrated in picoseconds are for a specific implementation of the buffer 502 and that the times will vary from one implementation to another. For the next delay setting 01b, the MID RISE is slow and the OUT FALL is fast providing a delay time of 14 ps for the fastest PVT corner. For the next delay setting 10b, the MID RISE is fast and the OUT FALL is slow providing a delay time of 17 ps for the fastest PVT corner. For the slowest delay setting 11b, the MID RISE is slow and the OUT FALL is also slow providing a delay time of 21 ps for the fastest PVT corner. It is appreciated that the delay time is distributed relatively evenly between fastest to slowest for the fastest PVT corner and that the slowest delay is almost twice that of the fastest delay.

The delay times for the slowest PVT corner are now considered. For the fastest delay setting 00b, the MID RISE is fast and the OUT FALL is also fast providing a fastest delay time of 22 ps for the slowest PVT corner. Again, the particular times illustrated in picoseconds are for a specific configuration of the buffer 502 and that the times will vary from one configuration to another. For the next delay setting 01b, the MID RISE is slow and the OUT FALL is fast providing a delay time of 28 ps for the slowest PVT corner. For the next delay setting 10b, the MID RISE is fast and the OUT FALL is slow providing a delay time of 35 ps for the slowest PVT corner. For the slowest delay setting 11b, the MID RISE is slow and the OUT FALL is also slow providing a delay time of 42 ps for the slowest PVT corner. Again, the delay time is distributed relatively evenly between fastest to slowest for the slowest PVT corner and that the slowest delay is almost twice that of the fastest delay.

It is appreciated that the fastest delay for the slowest PVT corner is about equal to the slowest delay for the fasted PVT corner (e.g., 21 ps versus 22 ps). The slowest delay of the slowest PVT corner is almost 4× the delay of the fastest delay of the fastest PVT corner. It is also appreciated that the actual PVT conditions may not specifically be known for any particular measurement so that the actual delay times may fall somewhere between the illustrated delay times. A calibration procedure may be performed to determine the delay settings as further described herein.

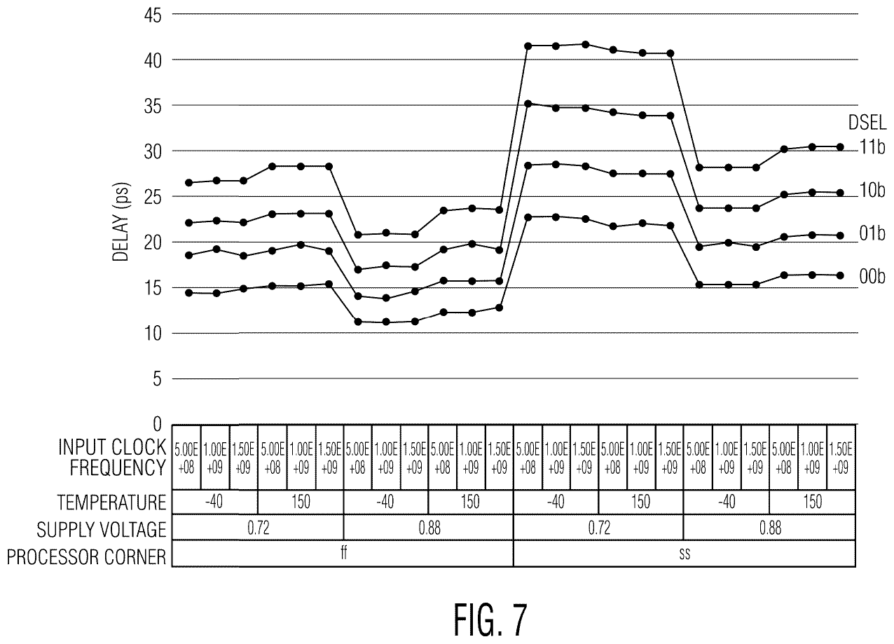

FIG. 7 is a plot of delay times of the buffer 502 (having the same implementation as described for FIG. 6) for each of the four settings of the enable signals of DSEL (00b, 01b, 10b, 11b) for various PVT conditions according to one embodiment. The PVT settings include three different clock frequencies 500 megahertz (MHz) (5.0E8), 1 gigahertz (GHz) (1.0E9), and 1.5 GHz (1.5E9), two different temperatures −40 and 150 in degrees Celsius (C.), two different supply voltages 0.72 Volts (V) and 0.88V, and for two different process variations denoted “ff” and “ss.” It can be seen that for any given set of PVT parameters, the delay setting using the DSEL signal (with 2 enable signals) provides 4 different buffer delays that are relatively equally distributed.

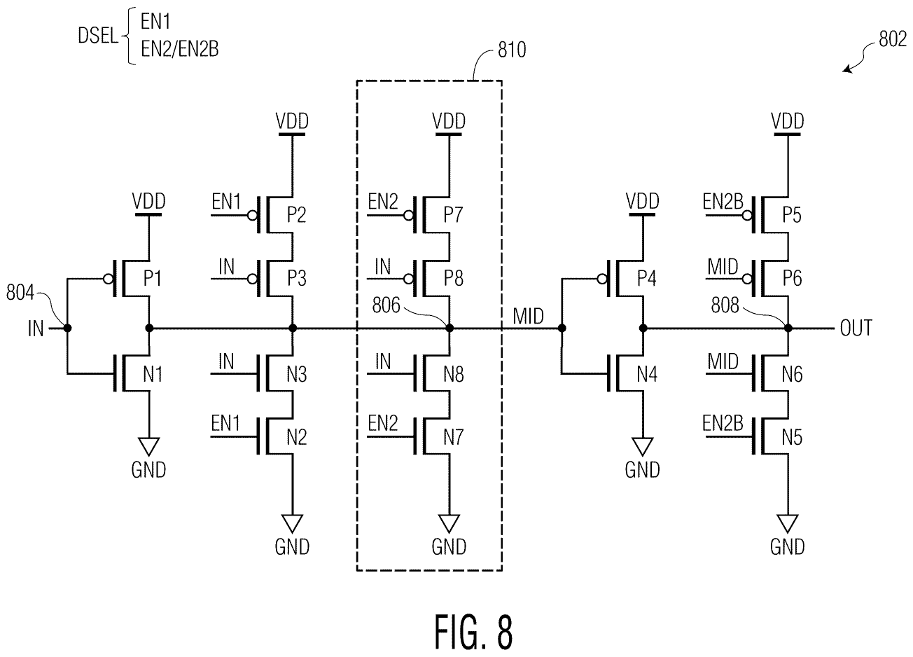

FIG. 8 is a schematic diagram of a programmable buffer 802 implemented according to another embodiment that may be used as any one up to all of the buffers B1-BN of the delay line 102 (e.g., delay lines 202 or 402 or the like). The illustrated buffer 802 is suitable for other types of technologies, such as smaller FinFET process nodes, although other technologies are contemplated. As an example, whereas the buffer 502 may be implemented using 16 nm technology, the buffer 802 may be implemented using 5 nm technology or the like. The buffer 802 is similar to the buffer 502 and includes similar devices coupled in a similar manner. The buffer 802 also includes PMOS and NMOS transistors with the same alphanumeric names, shown as PMOS transistors P1-P6 and NMOS transistors N1-N6, coupled between VDD and GND and coupled to an IN node 804, a MID node 806, and an OUT node 808 in substantially the same manner as the buffer 502. As with the buffer 502, the buffer 802 also includes an input inverter stage formed by P1 and N1, a first programmable stage formed by P2 and P3 and N2 and N3, a second inverter stage formed by P4 and N4, and a second programmable stage formed by P5 and P6 and N5 and N6. Also, the first programmable stage is controlled by enable signal EN1 and the second programmable stage is controlled by enable signal EN2B in substantially the same manner as the buffer 502.

In this case, in order to get the desired delay steps, the buffer 802 includes a third programmable stage 810 including additional PMOS transistors P7 and P8 and NMOS transistors N7 and N8. P7 has a source terminal coupled to VDD, a drain terminal coupled to the source terminal of P8, and a gate terminal receiving the enable signal EN2. P8 has a gate terminal coupled to the IN node 804 and a drain terminal coupled to the MID node 806. N8 has a drain terminal coupled to the MID node 806, a gate terminal coupled to the IN node 804, and a source terminal coupled to the drain terminal of N7. N7 has a gate terminal receiving EN1 and a source terminal coupled to GND. Although DSEL includes the three enable signals EN1, EN2, and EN2B in this configuration, the three enable signals are actually based on only two enable signals EN1 and EN2 since EN2B is an inverted version of EN2.

Operation of the buffer 802 is substantially similar to operation of the buffer 502 previously described, except that the third programmable stage 810 adjusts the relative delay of the rise time of MID for the four programmable delay values EN2/EN1=00b, 01b, 10b, and 11b. For the first two delay settings 00b and 01b, since EN2 is low, the third programmable stage 810 operates to further reduce the rise time of MID (as compared to the case in which the third programmable stage 810 is not provided). For the second two delay settings 10b and 11b, since EN2 is high, the third programmable stage 810 operates to increase the rise time of MID (again, as compared to the case in which the third programmable stage 810 is not provided).

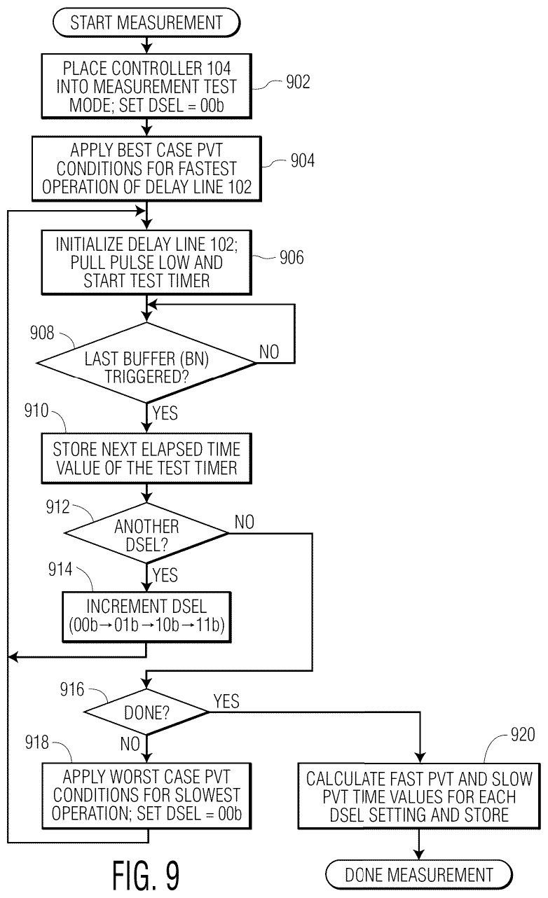

FIG. 9 is a flowchart diagram illustrating a delay line measurement test procedure according to one embodiment that may be used to determine the total timing of the delay line 102 for a given implementation. The total timing measurement is distinguished from measuring the delay of a timing pulse since measuring the propagation time of a falling edge through the entire delay line 102. The delay line measurement test procedure is performed when the TDC 100 is implemented in an SoC or semiconductor chip or integrated circuit (IC) or the like and when applicable PVT conditions may be controlled by external test equipment. The results of the delay line measurement test procedure are used to determine the actual delay values for fast PVT and slow PVT of a specific implementation of the buffers, which may then be stored in memory for reference during normal operation of the TDC 100. For example, the delay line measurement test procedure may be used to determine the specific time values shown in FIG. 6 for the specific implementation of the buffer 502. Although each and every SoC or chip may be tested for measuring actual timing values, such exhaustive testing may be prohibitive and may instead be performed on a representative set of SoCs or chips similarly implemented and manufactured using a selected manufacturing process. The measured delay values may be stored by each device similarly configured and implemented.

At a first block 902, the controller 104 is placed into a test measurement mode (such as, for example, by asserting the CTL signals accordingly), and DSEL is set to 00b for programming each of the buffers B1-BN of the delay line 102 for fastest (or lowest) buffer delay. At next block 904, the best-case PVT conditions are applied to the SoC or semiconductor chip or IC or the like incorporating the TDC 100 for fastest operation of the delay line 102. At next block 906, the delay line 102 is initialized, such as by holding the input PULSE signal high so that the outputs of all of the buffers B1-BN are pulled high, and then the PULSE signal is pulled low and a test timer is started in order to accurately measure total elapsed time. The test timer may be an external timer that is part of a test system performing the delay line measurement test procedure.

At next query block 908, the controller 104 determines whether the last buffer BN has triggered, meaning whether the initial falling edge of PULSE has propagated through the entire delay line 102. Operation loops (or waits) at block 908 until the last buffer BN triggers. When the last buffer BN triggers, operation advances to block 910 in which the first or “next” elapsed time value of the test timer is stored. This represents a total measured delay of the delay line 102 under the applicable DSEL setting and PVT conditions, such as the fastest DSEL setting (00b) and the optimal PVT conditions for the first iteration. Operation then advances to block 912 to determine whether the full delay of the delay line 102 needs to be measured for another, slower DSEL setting. If so, operation advances to block 914 in which DSEL is incremented to the next delay setting, e.g., from 00b 01b 10b 11b. After DSEL is incremented, operation loops back to block 906 to repeat the measurement for the next DSEL setting. Again, the delay line 102 is initialized, then PULSE is pulled low and the test timer is started again for measuring the full delay line and storing the elapsed time for the next DSEL setting. The measurement loop is repeated for each DSEL setting for the applicable PVT conditions (e.g., best-case PVT conditions).

When the delay line 102 has been measured for all DSEL settings as determined at block 912, operation instead advances to block 916 to determine whether the test operation is done, meaning whether the best-case and worse-case PVT conditions have been considered. If not, operation advances to block 918 in which the worst-case PVT conditions are applied for the slowest operation of the delay line 102, and DSEL is set back to the fastest setting 00b. Operation then loops back to block 906 to repeat the entire test for each of the DSEL settings for the worst-case PVT conditions, and corresponding time values of the test timer are stored.

When test operation is completed for both the best-case and worst-case PVT settings as determined at block 916, operation advances instead to block 920 in which the fast PVT and slow PVT time values for each DSEL setting are calculated and stored, and measurement operation is completed. For example, if the delay line 102 has 127 buffers, then each time value is divided by 127 to determine an average buffer delay value for each DSEL setting for both fast PVT and slow PVT as shown by the table in FIG. 6. The entire delay line measurement test procedure may be repeated for as many iterations as reasonably determined to calculate optimal averaged time values.

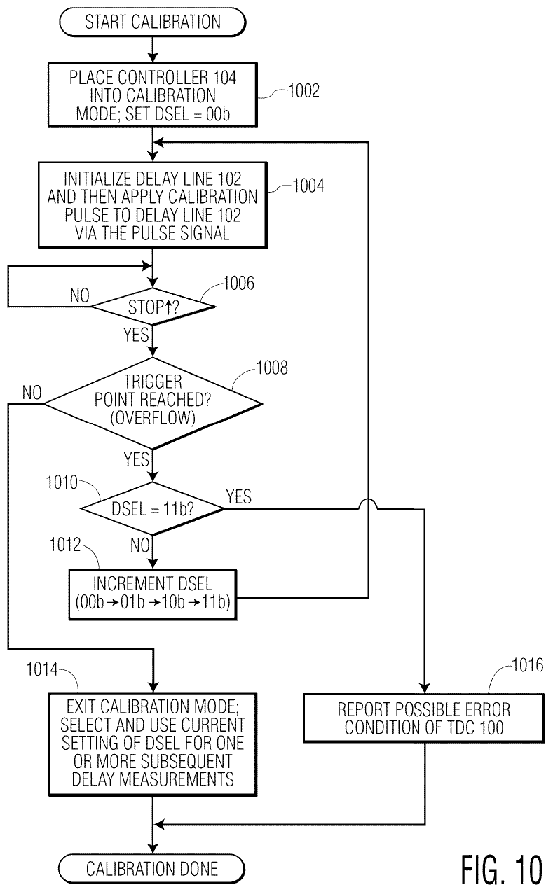

FIG. 10 is a flowchart diagram illustrating a first calibration procedure for calibrating the delay line 102 according to one embodiment. It is noted that for clock BIST applications, input time period does not vary much for a measurement other than by a jitter amount. Other than the STOP signal, an “overflow” signal (not shown) may be generated by the delay line 102 when a measurement reaches a point near the end. The overflow signal is generated if the output data is greater than the full delay of the delay line 102 minus a margin amount for jitter considerations. In one embodiment, for example, the margin may be determined by logically ANDing the 3 MSBs of DOUT for a delay line length of 127 units, meaning that the 112th buffer is transitioned, which may be considered an overflow condition allowing margin for 13% peak-peak jitter. Overflow implies that base unit is small and delay line might have overflow for clock period variation due to jitter. At the beginning of any measurement, or at least before any clock BIST measurement, automatic calibration may be used to select a suitable delay programming setting based on input time width. Such signal calibration is used to depict the calibration mode and the corresponding output data during calibration is not used for jitter and DC calculations. Other than for jitter considerations, calibration may be performed periodically for ensuring optimal delay measurements for current PVT conditions. Since PVT conditions may vary over time, calibration may be repeated as often as desired.

At a first block 1002, the controller 104 is placed into the calibration mode (such as, for example, by asserting the CTL signals accordingly), and DSEL is set to 00b for programming each of the buffers B1-BN of the delay line 102 for fastest (or lowest) buffer delay. At next block 1004, the delay line 102 is initialized (such as by keeping PULSE high for a sufficiently long period), and then a calibration pulse is applied to the delay line 102 via the PULSE signal. In a similar manner as each timing pulse previously described, the calibration pulse begins with a falling edge signal on PULSE (e.g., START). Operation loops at next block 1006 until the calibration pulse is completed, such as detecting a rising edge signal STOP on the PULSE signal triggering a pulse on the STOP signal.

It is noted that the calibration pulse may be the first timing pulse (or a first set of timing pulses) to be measured in a subsequent measurement cycle. For example, when measuring the period of CLK_UT as shown in FIG. 2, the first one or more pulses may be used as calibration pulses. Calibration cycles are distinguished from normal measurement cycles in that DOUT is not used for measuring the duration of the calibration pulse. Alternatively, the calibration pulse may be a longer pulse based on the actual timing values (such as, for example, those timing values stored in response to test measurements determined by a delay line measurement test procedure shown in FIG. 9) and current PVT conditions. The longer calibration pulse may be selected with a duration at or near the expected full delay of the delay line 102.

When STOP is detected as determined at block 1006, operation advances to block 1008 to determine whether the trigger point of the delay line 102 has been reached. In one embodiment, the trigger point is not the very last buffer BN, but instead is an earlier buffer near the end of the delay line 102 allowing margin for peak-peak jitter. In one embodiment in which the delay line 102 includes a total of 127 buffers, the trigger point may be the 112th buffer (out of a total of 127 buffers) to allow for a 13% peak-peak jitter as previously described. The trigger point is selected for determining an overflow point, in which overflow implies that the delay unit is small so that the delay line 102 may have overflow for clock period variation due to jitter.

If the trigger point is reached as determined at block 1008, then an overflow may occur so that operation proceeds to block 1010 in which it is queried whether DSEL=11b meaning that the maximum value of DSEL has been reached. If additional DSEL settings are available, operation advanced to block 1012 in which DSEL is incremented by one to incrementally increase the buffer delay, and operation loops back to block 1004 to initialize and then apply the calibration pulse again to the delay line 102. Operation loops between blocks 1004-1012 until the first iteration in which the trigger point is not reached as determined at block 1008. When the trigger point is not reached, operation instead advances instead to block 1014 in which calibration mode is exited and the current setting of DSEL is used for one or more subsequent delay measurements and calibration is completed.

Referring back to block 1010, if the trigger point has been reached at the maximum setting of DSEL (e.g., 11b), then operation instead advances to block 1016 in which a possible error condition of the TDC 100 is reported and calibration is completed. Responses to an error condition are beyond the scope of this disclosure. It is possible that additional measurements may be made to adjust the buffer delay values as shown in FIG. 6 for the particular implementation.

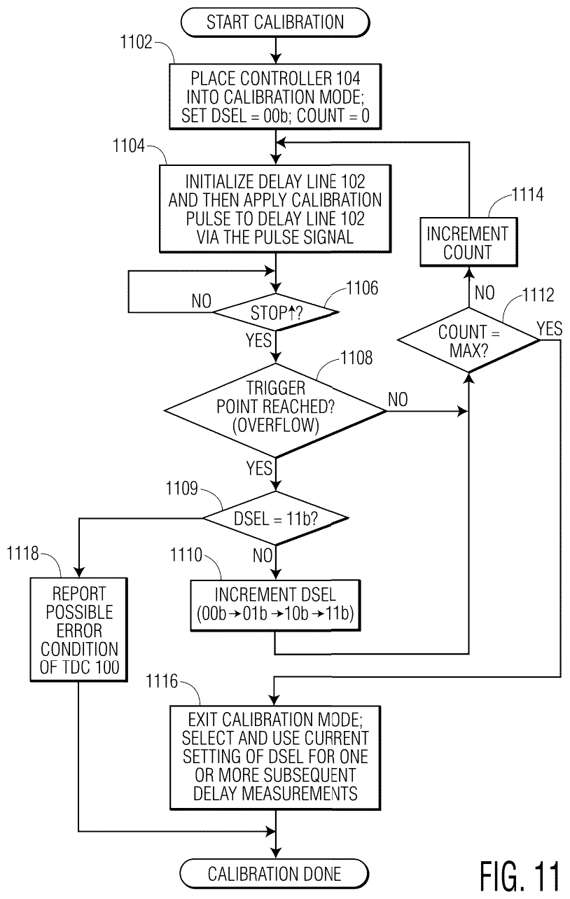

FIG. 11 is a flowchart diagram illustrating a second calibration procedure for calibrating the delay line 102 according to another embodiment. Calibration may be performed by the controller 104 periodically for ensuring optimal delay measurements for current PVT conditions. A first block 1102 is similar to the block 1002, in which the controller 104 is placed into the calibration mode and DSEL is set to 00b for the fastest (or lowest) buffer delay. In addition, a COUNT value is initialized to 0. A next block 1104 is the same as block 1004, in which the delay line 102 is initialized and then a calibration pulse is applied to the delay line 102 via the PULSE signal. Operation loops at next block 1106 in the same manner as block 1006 until the calibration pulse is completed, such as detecting a rising edge signal STOP on the PULSE signal trigger a pulse on the STOP signal.

When STOP is detected at block 1106, operation advances to block 1108 which is similar to block 1008, in which it is determined whether a trigger point of the delay line 102 has been reached. If the trigger point has been reached as determined at block 1108, then an overflow may occur so that operation proceeds to block 1109, which is similar to block 1010, in which it is queried whether DSEL=11b meaning that the maximum value of DSEL has been reached. If additional DSEL settings are available, operation advances to block 1110, which is similar to block 1012, in which DSEL is incremented by one to incrementally increase the buffer delay. In this case, after DSEL is incremented at block 1110, or if the trigger point has not been reached as determined at block 1108, operation advances to a block 1112 in which it is queried whether COUNT is equal to a number MAX. If not, COUNT is incremented at a next block 1114, and operation loops back to block 1104 to initialize and then apply the calibration pulse again to the delay line 102. Operation loops between blocks 1104-1110 until COUNT=MAX as determined at block 1112. When the MAX count is reached, operation instead advances instead to block 1116, which is similar to block 1012, in which calibration mode is exited and the current setting of DSEL is used for one or more subsequent delay measurements and calibration is completed.

Referring back to block 1109, if the trigger point has been reached at the maximum setting of DSEL (e.g., 11b), then operation instead advances to block 1118, which is similar to block 1016, in which a possible error condition of the TDC 100 is reported and calibration is completed. Again, responses to an error condition are beyond the scope of this disclosure, although it is possible that additional measurements may be made to adjust the buffer delay values as shown in FIG. 6 for the particular implementation.

The second calibration procedure is similar to the first calibration procedure except that a fixed number of MAX iterations are performed regardless of whether the trigger point has been reached during any given iteration. The value MAX may be selected as a reasonable number, such as, for example, MAX=8 for a fixed number of 8 iterations. It is appreciated that MAX may be programmed to any other reasonable number of iterations for a given configuration.

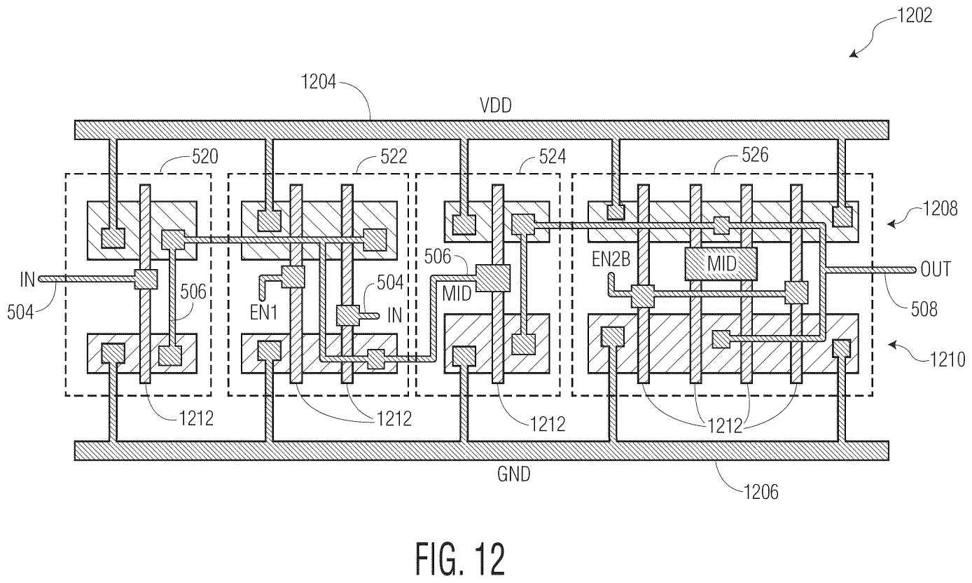

FIG. 12 is a diagram of a standard cell structure 1202 configured to implement the buffer 502 according to one embodiment. The standard cell structure 1202 is positioned between and coupled to an upper rail 1204 developing the supply voltage VDD and a lower rail 1206 developing the reference supply voltage GND. An upper horizontal series of shaded areas 1208 depict P+ diffusion layers (e.g., P+ doped regions or Pwells formed within underlying Nwell substrates) form the drain and source terminals of the PMOS transistors P1-P6, and a lower horizontal series of shaded areas 1210 depict N+ diffusion layers (e.g., N+ doped regions or Nwells formed within underlying Pwell substrates) form the drain and source terminals of the NMOS transistors N1-N6. A series of vertical shaded bars depict poly regions 1212 that form the gate terminals of the PMOS and NMOS transistors. The standard cell structure 1202 forms the input inverter stage 520, the first programmable stage 522, the second inverter stage 524, and the second programmable stage 526.

Darker shaded lines depict VDD and GND rails and conductive traces or the like which include solid square-shaped or rectangular-shaped shaded blocks depicting electrical connections to the underlying diffusion layers and poly regions. In this manner, the source terminals of PMOS transistors P1, P2, P4, and P5 are coupled to VDD, and the source terminals of NMOS transistors N1, N2, N4, and N5 are coupled to GND. Also, the input node 504 is coupled to the gate terminals of P1 and N1. In addition, the MID node 506, which includes a shaded block labeled “MID,” is coupled to the drain terminals of P1, N1, P3, and N3 and to the gate terminals of P4, N4, P6, and N6. Furthermore, the OUT node 508 is coupled to the drain terminals of P4, N4, P6, and N6. Also, EN1 is coupled to the gate terminals of P2 and N2, and EN2B is coupled to the gate terminals of P5 and N5.

In one embodiment, the standard cell structure 1202 is configured by retrieving a standard cell AND gate or a standard cell OR gate (or other applicable standard cell structures) from a standard cell library for the underlying technology (e.g., 16FFC) and modifying the conductive connections (e.g., by replicating the N side connections to the P side for the standard cell AND gate, or by replicating the P side connections to the N side for the standard cell OR gate) to implement the functionality of the buffer 502. It is noted that each poly region 1212 forms a common gate terminal of corresponding PMOS and NMOS transistors as required for typical standard cell layout.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims. For example, variations of positive circuitry or negative circuitry may be used in various embodiments in which the present invention is not limited to specific circuitry polarities, device types or voltage or error levels or the like. For example, circuitry states, such as circuitry low and circuitry high may be reversed depending upon whether the pin or signal is implemented in positive or negative circuitry or the like. In some cases, the circuitry state may be programmable in which the circuitry state may be reversed for a given circuitry function.

The terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

We claim:

1. A time to digital converter, comprising:
a plurality of programmable buffers coupled in series including a first buffer having an input receiving a pulse signal, wherein each of the plurality of programmable buffers is configured with an adjustable delay based on a delay select input;
a plurality of latches, each having an input coupled to an output of a corresponding one of the plurality of buffers, each having a clock input receiving a stop signal, and each having an output configured to provide a corresponding one of a plurality of binary values; and
a phase converter configured to convert the plurality of binary values into a digital output value indicative of a measured delay of a timing pulse asserted on the pulse signal.

2. The time to digital converter of claim 1, wherein the adjustable delay is used to select from among a plurality of different transition delays from an input node to an output node of each of the plurality of programmable buffers.

3. The time to digital converter of claim 1, wherein each of the plurality of programmable buffers comprises an input inverting stage coupled between an input node and a middle node and an output inverting stage between the middle node and an output node, and wherein the adjustable delay is configured to select, based on the delay select input, a rising edge delay of the middle node in response to a falling edge of the input node, and to select a falling edge delay of the output node in response to the rising edge delay of the middle node.

4. The time to digital converter of claim 3, wherein the delay select input comprises a first enable signal and a second enable signal, and wherein each of the plurality of programmable buffers further comprises:
a first programmable branch coupled to the middle node configured to adjust the rising edge delay of the middle node based on the first enable signal; and
a second programmable branch coupled to the output node configured to adjust the falling edge delay of the output node based on the second enable signal.

5. The time to digital converter of claim 4, wherein each of the plurality of programmable buffers is configured in complementary MOS (CMOS), wherein the first programmable branch comprises a P-type MOS (PMOS) transistor and an N-type MOS (NMOS) transistor each having a gate terminal receiving the first enable signal, and wherein the second programmable branch comprises a PMOS transistor and an NMOS transistor each having a gate terminal receiving the second enable signal.

6. The time to digital converter of claim 5, wherein each of the programmable buffers comprises a plurality of CMOS transistors configured in FinFET compact technology.

7. The time to digital converter of claim 3, wherein the delay select input comprises a first enable signal and a second enable signal, and wherein each of the plurality of programmable buffers further comprises:
a first programmable branch coupled to the middle node configured to adjust the rising edge delay of the middle node based on the first enable signal;
a second programmable branch coupled to the middle node configured to adjust the rising edge delay of the middle node based on a second enable signal; and
a third programmable branch coupled to the output node configured to adjust the falling edge delay of the output node based the second enable signal.

8. The time to digital converter of claim 7, wherein each of the plurality of programmable buffers is configured in complementary MOS (CMOS), wherein the first programmable branch comprises a P-type MOS (PMOS) transistor and an N-type MOS (NMOS) transistor each having a gate terminal receiving the first enable signal, wherein the second programmable branch comprises a PMOS transistor and an NMOS transistor each having a gate terminal receiving the second enable signal, and wherein the third programmable branch comprises a PMOS transistor and an NMOS transistor each having a gate terminal receiving an inverted version of the second enable signal.

9. The time to digital converter of claim 8, wherein each of the programmable buffers comprises a plurality of CMOS transistors configured in FinFET technology.

10. The time to digital converter of claim 1, wherein each of the plurality of programmable buffers is configured to be compatible with a standard cell layout.

11. The time to digital converter of claim 1, further comprising:
a controller configured to calibrate the plurality of programmable buffers by applying a calibration pulse on the pulse signal, adjusting a delay select signal provided to the delay select inputs of the plurality of programmable buffers, and selecting a fastest value of the delay select signal that does not cause overflow of the plurality of programmable buffers in response to the calibration pulse.

12. A method of converting time to a digital value, comprising:
providing a plurality of programmable buffers coupled in series including a first buffer having an input receiving a pulse signal, wherein each of the plurality of programmable buffers is configured with an adjustable delay based on a delay select input;
asserting a timing pulse on the pulse signal, wherein the timing pulse has a leading edge and a trailing edge;
latching outputs of the plurality of programmable buffers in response to the trailing edge of the timing pulse and providing a corresponding plurality of binary values; and
converting the plurality of binary values into a digital output value indicative of a duration of the timing pulse.

13. The method of claim 12, further comprising providing a delay select signal to the delay select input of each of the plurality of programmable buffers to select from among a plurality of different transition delays from an input node to an output node of each of the plurality of programmable buffers.

14. The method of claim 12,
wherein said providing a plurality of programmable buffers comprises providing an input inverting stage coupled between an input node and a middle node and an output inverting stage between the middle node and an output node for each of the plurality of programmable buffers; and
providing a delay select signal to the delay select input of each of the plurality of programmable buffers to select a rising edge delay of the middle node in response to a falling edge of the input node and to select a falling edge delay of the output node in response to the rising edge delay of the middle node for each of the plurality of programmable buffers.

15. The method of claim 14,
wherein said providing a plurality of programmable buffers further comprises, for each of the plurality of programmable buffers:
providing a first programmable branch coupled to the middle node configured to adjust the rising edge delay of the middle node based on a first enable signal; and
providing a second programmable branch coupled to the output node configured to adjust the falling edge delay of the output node based on a second enable signal; and
providing the first and second enable signals to the delay select input of each of the plurality of programmable buffers to select from among a plurality of different transition delays from an input node to an output node of each of the plurality of programmable buffers.

16. The method of claim 15, further comprising providing a third programmable branch coupled to the middle node configured to further adjust the rising edge delay of the middle node based on the second enable signal.

17. The method of claim 12, wherein said providing a plurality of programmable buffers comprises providing each of the plurality of programmable buffers to be compatible with a standard cell layout.

18. The method of claim 12, wherein said providing a plurality of programmable buffers comprises providing each of the plurality of programmable buffers as a standard cell logic gate with modified connections.

19. The method of claim 12, further comprising:
providing a fastest delay select value of a plurality of different delay select values to the delay select input of each of the plurality of programmable buffers;
asserting a calibration pulse on the pulse signal;
determining whether an overflow condition of the plurality of programmable buffers occurs;
if the overflow condition occurs, incrementing the delay select value to a next slowest delay select value and repeating said asserting a calibration pulse and determining whether an overflow condition occurs until the overflow condition does not occur.

20. The method of claim 12, further comprising:
providing a fastest delay select value of a plurality of different delay select values to the delay select input of each of the plurality of programmable buffers;
performing calibration, comprising:
asserting a calibration pulse on the pulse signal;
determining whether an overflow condition of the plurality of programmable buffers occurs;
if the overflow condition does not occur, repeating said performing calibration for up to a maximum count while the overflow condition does not occur; and
if the overflow condition occurs, incrementing the delay select value to a next slowest delay select value and repeating said performing calibration.
